(19) United States
(12) Patent Application Publication
(10) Pub. No.: US 2006/0259590 A1
(43) Pub. Date: Nov. 16, 2006

(54) Online printing service system on the Internet

(76) Inventors: Chung-Cheng Tsai, Taipei City (TW); His-Chia Chen, Taipei City (TW)

Correspondence Address: Chung-Cheng Tsai, 235 Chung - Ho, Box 8-24, Taipei, TW

(21) Appl. No.: 11/413,905

(22) Filed: Apr. 28, 2006

(30) Foreign Application Priority Data
May 10, 2005 (TW) 094115178

(51) Int. Cl. G06F 15/16; G06F 17/00; G06F 15/00

(52) U.S. Cl. 709/219; 715/530

(57) ABSTRACT

An online printing service system on the Internet at least comprises a client computer, a web server, a website for providing web editing and other publication services, a database management system for saving data related to editing and other publication matters and retrieving the stored data by predetermined websites and users, a web interface for providing a user with an interactive interface with the website and an online or offline editor for providing a user with reinforcing online or offline editing operations. Thereby, a user can use the system to accomplish the processes of editing, typesetting and publication on Internet.

### FIELD OF THE INVENTION

The present invention related to online, real-time printing services, more particularly to an online printing service system on the Internt.

### BACKGROUND OF THE INVENTION

The fast growing e-commerce industry has extended to the printing business, which traditionally needs high-quality treatment. However, the web interface for providing online printing services has much room to improve, given its limited capability to handling Chinese characters. Further, the integration of various publication procedures is still far from ideal. The printing business does not allow a slightest bit of imperfection in the final printed material. However, the current web printing service cannot provide a user at the client end with the final printing quality a traditional printing business can provide, because of the limited online resources. Therefore, the online printing service has limited market.

The invention of the prior art disclosed by R.O.C. patent number 514808, online business card ordering method and the system used the same, utilizes the Internet to retrieve data from a database storing clients'data and respective business-card templates, to print the business cards and to send to the clients. This invention has the advantage of providing clients with the flexibility of different styles to choose, a breakthrough from the conventional business card styles. However, this invention of the prior art does not transfer the business card images into vector graphics, and the service items are not enough. Further, the invention of the prior art disclosed by Taiwan (R.O.C). patent number 533142, business card typesetting method and the device used the same, avoids rebuilding the card content when a change in style is necessary. However, the characters displayed in a card are not vector graphics, and the associated printing service items are not fully integrated.

### SUMMARY OF THE INVENTION

Accordingly, the primary objective of the present invention is to provide an online printing service system on the Internet, whereby the quality and the service range of online publication will be enhanced. Consequently, the online resources are integrated, and the associated economic efficiency is promoted. The secondary objective of the present invention is to provide an online printing service system on the Internet utilizing e-commerce measures to significantly reduce the communication between a client and a service personnel of the printing company, thereby reducing the production cost and enhancing the publication speed and quality.

Meanwhile, the specific way of improving the quality of online publication concerns the steps of:

(1) transforming the characters into vector graphics; (2) compressing the vector graphics; (3) reducing the file size of bitmap images; (4) editing the job to print by online VML technique; and (5) mapping RGB to CMXY online. Thereby, the quality of publication will be high. More specifically, the details in each steps are listed as follows.

(1) transforming the characters into vector graphics: using Visual C++ and ATL to develop ActiveX kernels for being called by other ASP programs and VB programs; thereby, the characters in UNICODE or BIG5 formats being saved in the EMF(Enhanced-Format Metafile) format from the original TrueType files through a Microsoft GDI+ API application; therefore, the characters are represented in vector graphics for web applications.

(2) compressing the vector graphics: using visual C++ to develop programs so as to compress the WMFand EMF files into Compressed Windows Metafiles (attributed by WMZ or EMZ); using ZLIB standard compression algorithm to convert Windows Enhanced-Format Metafiles into EMZ files (Compressed Windows Enhanced-Format Metafile), thereby facilitating file transport on the Internet.

(3) reducing the file size of bitmap images:using the function of picture shrinking provided by the Microsoft GDI+ API application to shrink the BMP files (or JPEG,PNG files); using GDI and HalfTone to produce high-qulaity, low-size shrunk pictures; the function of HalfTone making up for downgrading due to deleted pixels.

(4) editing the job to print by online VML technique: using DHTML Java JavaScript and Remote Script to develop an online typesetting and editing webpage; the webpage being saved as a VML file so that a client can interact with the system through the webpage, using JavaScript language, by an IE browser with the DHTML specification published by W3C organization; the system further including editing functions, such as insertion, deletion, shifting, Zoom In/Out and VML Shape objects alignment, also written in VML using JavaScript; using Java language (by Sun corporation) to execute a Remote Script for transforming a text into an EMZ compressed vector graphic and sending the EMZ fiel back to the client end for display.

(5) mapping RGB to CMXY online: precisely preserving the original colors in the VML documents by utilizing a RGB-to-CMYK conversion table.

Therefore, the present invention will provide an online printing service system on the Internet, which does not need to install special editing software and character fonts. The clients are not necessary to be skilled in artistic design, since standard templates are available. The exact format of the original pieces of work to print is preserved and displayed online, which enables high-qulaity online publication service.

### BRIEF DESCRIPTION OF THE DRAWINGS

FIG. 1 is a flow chart of an online printing service system of the prior art.

Figs. 2A to 2C shows three flow charts demonstrating how the online printing service system of the present invention works.

FIG. 3 introduces the functions of various domains on the editing interface of the present invention.

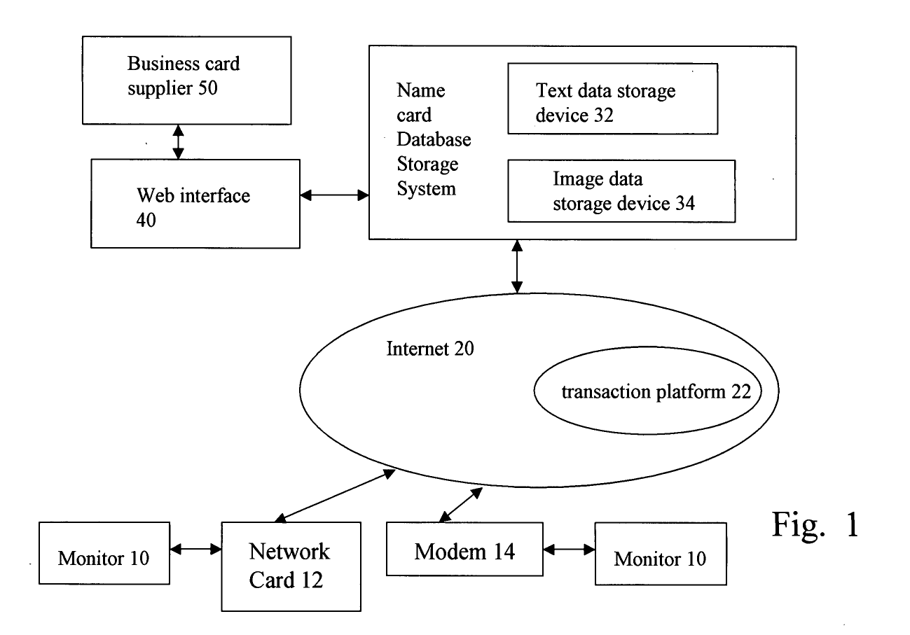

### DETAILED DESCRIPTION OF THE PREFERRED EMBODIMENTS

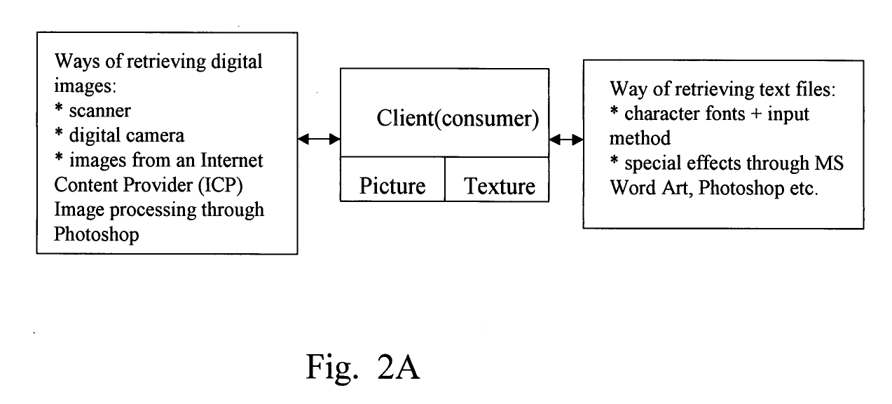

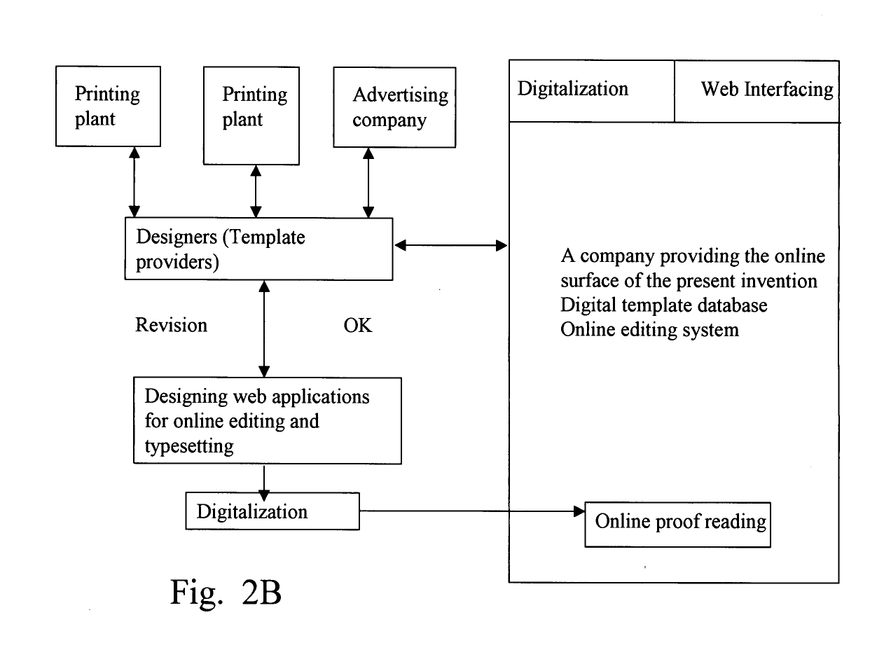

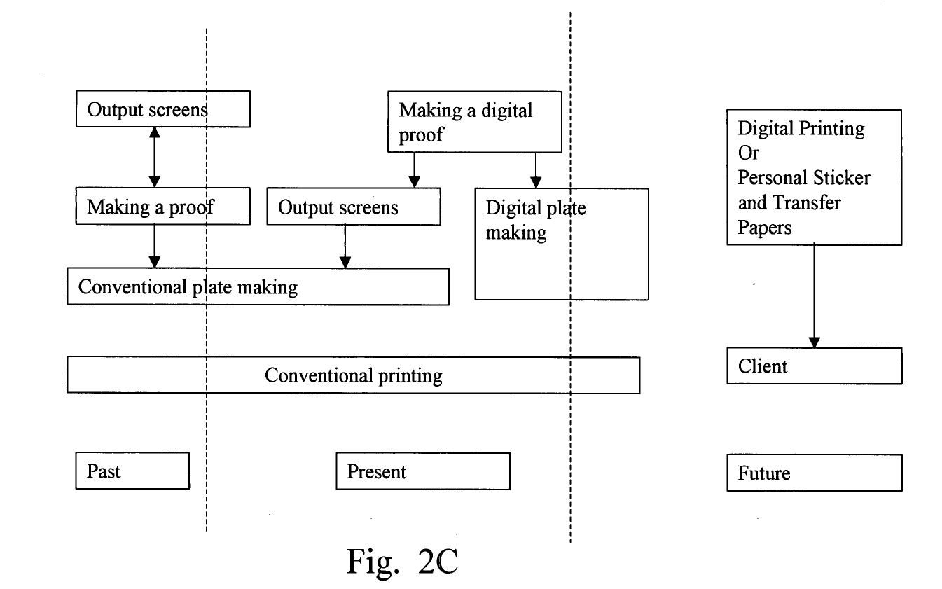

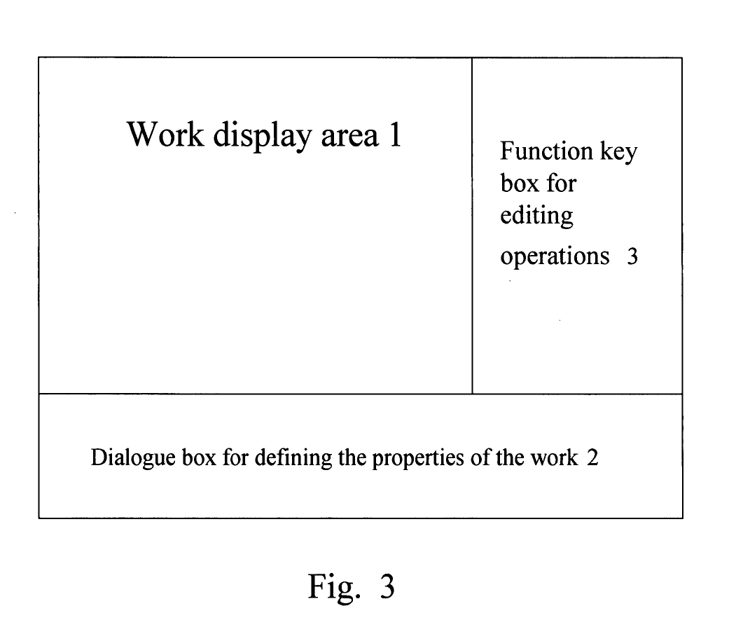

The various objects and advantages of the present invention will be more readily understood from the following detailed description when read in conjunction with the appended drawings. Referring to FIG. 4, the system of the present invention provides an user with online operations via a predetermined standard webpage. User only needs to input text data, clip on desired functions and drag other available objects around on the webpage, thereby completing the electronic file to print. Therefore, the webpage as an operation interface is called an editor. The editor is for an user to accomplish various processes for a professional publication. The editor is shown in FIG. 3. Referring to FIG. 3, the editor is divided into a work display area 1, a dialogue box for defining the properties of the work 2 and a function key box for editing operations 3. The work display area 1 is shown in FIG. 3. Referring to Figs.2A to 2C, the online printing service system on the Internet of the present invention can replace the time-consuming communication between a client and a customer service clerk, which may include examining the manuscripts and sampling printing scripts. Further, the online printing service system on the Internet of the present invention makes an international service possible. For example, a local company is in charge of marketing, customer service and providing operational interface; it is defined as a front end of the server. The work completed by a local client will be sent through the Internet to a rear end of the server (could be in Taiwan). Thereby, a local client after finishing the editing and the associated publication procedures just pressed order online, the transaction record is directly delivered to a coordinated printing factory to print the piece of work. After the examination related to quality control of the factory, the printed material will be delivered to the local client by a mailing service.

The detailed embodiments of the present invention are illustrated as follows.

1. Object-oriented format: The editing interface between the client end and the server end is designed to be online and cross-platform, whereby installing special editing software at the client end is not necessary. To form an object-oriented formated file, there are the following steps:

a. online editing and typesetting: There is no need to install professional editing and typesetting software, text fonts and figure database in a B2C client's computer. Each of the objects in a piece of work being edited can be chosen to edit independently. The editing operations can be moving the object, inputing text, changing default format . . . , whereby the text input, font setting and color selection can be easily accomplished online via the Internet. Therefore, the function keys on the web interface are as picture-like as possible.

b. one-time data entry: The data displayed on a card template, such as name, job title, extension number, e-mail, mobile phone number. . . etc., do not have to be keyed in again as the template is changed, since the data is saved in a database first. Therefore, re-examination of the card data after a switch of card template is not necessary.

c. template sharing: Since clients use the same database, the system allows sharing files or templates among them by permission of other clients and/or with a service charge. Thereby, the cost of online editing electronic files is further reduced.

2. Transformation of the online text fonts into vector graphics: Since the server end may not have the character fonts (especially non-English characters) a client are using at the client interface, the characters used by a client are transformed into vector graphics, whereby missing characters or replaced characters in the final electronic file to print will be impossible.

3. Enhancing graphic processing of the vector graphics and geometric graphics by VML format: Coupled with the techniques of vector graphics and the EMF/WMF formats, the “shape” and “group” of VML application can be more easily treated, and the online editor may have more complete functions.

4. Control of color domain for web coloring within the CMXY domain:

Referring to FIG. 3, what color is seen on the web and what color is gotten in the printed version has been a lasting problem in the field of CMS (Color Management System). Especially for clients using web browser (such as Intent Explorer) to display colors by the RGB mechanism, the server end prints by the CMYK mechanism, which has a narrower domain than the RGB mechanism. How to restrict the RGB color range within the CMYK range is an important problem to tackle. In the present invention, a conversion table from RGB to CMYK is utilized, so that the colors a client choose at the web interface can be automatically transferred.

5. Online examination of the manuscript: The online function of previewing the printed job for a client to re-examine is provided. With respect to colors, the RGB to CMYK control method can provide more realistic preview online, whereby the cost of making a proof is saved.

6. Online automatic price valuation and order inquiry: After a user selected the paper type and quantity to print, a web application program automatically calculate the price based on a set of predetermined unit prices and display the price, together with an order form. After the client confirm the purchase order, the server end of the system will download the order form and transfer to a cooperated printing plant.

The present invention integrates printing business and web service, whereby the whole process of publication will be done on the Internet. The present invention provides the following functions concerning web-facilitating publication.

1. A transaction of printing can be totally done on the Internet via online template selection→online editing→online sample printing and price valuation→online purchasing, which includes the following functions.

(1) Standard electronic files to print are presented on a web interface and further classified to search.

(2) The online editing is performed on the web version of the electronic files for printing, therefore negating the necessity of installing professional editing software and character fonts.

(3) The price of the completed electronic files to print can be evaluated by the system after the selection of paper type and quantity to print.

(4) A template can be recycled by replacing the original text data by other text data, such as name, job title, e-mail address, extension phone number . . . etc. Therefore, designing a card template is an one-time effort.

(5) Registered members can share their files, facilitating the use of the system by beginning users.

(6) Online checking of the purchase status is allowed.

The present invention can provide the following advanced functions:

The front end and rear end of the server are separated, which can be far away and connected by the Internet. Thereby, the rear end can publish web templates corresponding to the electronic files for printing at the front end; the purchasing orders and the electronic files to print are delivered from the front end to the rear end, making an international business possible. The characters input online are transformed from Big5 to Unicode, namely vector graphics, whereby characters associated with Japanese, Korean, European languages. . . etc can be handled. An online conversion table from RGB colors to CMYK colors is provided, so that a user can directly input CMYK values for colors. The downloaded electronic files to print are calibrated again against a CMYK table, assuring the possible deflection of colors within 10% of the CMYK values. Improved algorithms for online file compression of the vector graphics and the file saving are used.

More editing functions are allowed in the online VML editor. Regarding the web operation interface and the service flow for the advanced functions,

a. the layers and the clip number of a function are reduced;

b. the user interface is more friendly and faster;

c. the languages of the user interface can be at least Chinese, English and Japanese.

The Internet editing and publishing techniques of the prior art require the clients to use fixed templates, wherein the character fonts are consistent with those already installed at the client end. The images can be uploaded by the clients from their end to the server end, whereby the images will combined with the input characters into a picture-like lump (not object-oriented) in forms of JPG, GIF or PDF, which cannot be edited further. The combined files are mainly for previewing, capable of being edited through two processes of web decomposition, which is time-consuming and lacks editing functions.

Therefore, the current online printing and editing services have the following drawbacks:

editing at the client end depending on files downloaded from the server end which is not object-oriented; and poor capability of handling online characters and colored images, namely, being unable to use the character fonts in a client-end computer to complete the online editing; being short of capability for handling geometric shapes and vector graphics; and the inconsistency between the RGB colors on the Internet and the CMYK colors for printing.

Therefore, there exists a bottleneck that the clients fully rely on files downloaded from the server end which is not object-oriented.

Accordingly, the present invention applies techniques of object-oriented formatting that provides a platform for online editing.

As a result, the client end does not need to install any professional editing software, and the operations at the interface are simple.

A preferred embodiment:

The VML format is an extension from the XML tag language. The present invention uses the VML format to carry and exchange data, whereby:

The client end can browse the file through the Internet;

The server end can use an editing program with AddIn functions written in the VC++ and VB languages. The necessary setting concerning professional printing, such as page setting, page size, price, pricing unit, cutting line, fold line, . . . etc., can be embedded in various objects forming a file. Further, the file produced by the editing program can be posted at the client end for preview and search. A B2C client may choose a web-displayed template first, and the computer system will relate the file with corresponding professional settings for printing.There is no need to install any professional editing program at the client end; the client edits the design work online through a VML interface.

The client at the client end will not use the server-end functions, except for open files, save files and editing objects in a file. All other frequently used functions, such as alignment, object rendering. . . etc., are done at the client end. The editing of characters is like modifying a fugure, largely enhancing the flexibility of displaying characters. Further, the client can use a wide range of characters, including many countries.

As described in the prior art, the current online image processing lacks powerful capability for handling geometric shapes and vector graphics. Therefore, images are often shown in JPG, GIF and Bitmap formats.

The JPG gormatted image is a mixture of figures and text. Further, the black color in a JPG document is produced by four colors, therefore blurring black characters when it is printed.

Printing using the Bitmap document is usually more than 300 dpi in resolution. Since what we see on a computer screen are images with a resolution 72 dpi. This inconsistency in resolution often causes argument between the business provider and his clients.

The GIF document is too simple to be considered in the printing industry.

Technology application: In this present invention, the VML formatted files are used so as to enhance the online capability of handling geometric shapes and vector graphics. The files saved in the EMF and WMF formats can properly control the “shape” and “group” structures in a VML file. Therefore, an online editing and typesetting system including a variety of functions is realized.

With respect to the problem of color difference, a control scheme limiting the RGB colors within the CMYK color range is invented.

Although CMS (Color Management System) is a wide subject, the present invention indeed provides a practical method of controlling the problem of color difference in online color editing, which contains two parts: building a conversion table between the RGB colors and the CMYK colors for the use at both of the client end and the server end; and building an online interface for inputing the CMYK values so as to limit the RGB colors within the CMYK color range is invented.

Online preview, proof reading and price valuation: As described above, it is necessary for a client to see what he or she will get online. Accordingly, the present invention includes functions of online preview, proof reading and price valuation. With respect to the problem of color difference, a control scheme limiting the RGB colors within the CMYK color range is invented.

After a client finishes online purchase, the data of embedded in a web printing template will be combined with the conventional work sheet and sent to a printing facility. The online editing, typesetting and publication will execute the steps at least of: (1) transforming online characters to vector graphics; (2) compressing said vector graphics representing said online characters; (3) compressing online bitmap images; (4) online editing through VML; and (5) online RGB/CMYK color conversion. Thereby, content to print will be obtained in vector graphics and with quality of bitmap images.

The step of transforming online characters to vector graphics utilizes ActiveX kernel components written in Visual C++ and ATL for being called by an ASP or VB NET program. The retrieval of the vector data of a character (in TrueType) counter is through a GDI+ API application function, thereby making a BIG5 or UNICODE character into a vector graphic. The vector graphic are saved in EMF (Enhanced-Format Metafile) format in order to replace the online characters by images.

The step of compressing online bitmap images utilizes a C++ compression program to compress WMF and EMF files into Compressed Windows Metafiles, in either WMZ or EMZ format, which are compatible with the windows operational system. The compression is taken form a ZLIB library of standard algorithms, which is capable of compressing Windows Enhanced-Format Metafile into EMZ (Compressed Windows Enhanced-Format Metafile) files for facilitating web transmission.

The step of compressing online bitmap images utilizes GDI+ and HalfTone to produces small-size files selected from BMP (bitmap), JPEG and PNG formats. The small images for online preview are resized by an application program developed in GDI+API and HalfTone technique, whereby the deleted pixels in resizing the original image will be compensated by a smooth algorithm to attain small images of netter quality.

The step of VML online editing utilizes a web application developed by a language selected from DHTM, Java, JavaScript and Remote Script, and saved in the VML format, whereby a user at a client end will interact with the web application through the JavaScript language. A web browser for said web application can be MS Internet Explorer with DHTML specification published by W3C organization. The system provides a user with JavaScript functions of editing a VML document, such as “open new”, deletion, moving, Zoom In/Out and aligning VML Shape objects. Further, the system allows a user to command a Remote Script written in the Java language published by SUN Corporation for the use of transforming a document being edited into EMZ compressed vector graphics at the server end and, at same time, to deliver the EMZ document back to the client end for further editing.

The step of online RGB/CMYK color conversion provides a user with a RGB color table restricted to CMYK color range, whereby all the colors contained in the VML file will be correctly converted into effective CMYK values, so that the printed work after the online editing will have correct colors.

Regarding making a proof and proof reading, the process is separated into an online part and an offline part:

1. Online proof reading that suitable for printing job with greater allowance for color differences and of small quantity.

A. content (performed on MS Internet Explorer):

a. online, real time multiple template fitting and examining, in contrast to the current domestic (in Taiwan) technique of single template fitting and examining.

b. online real time proof production, in contrast to the current domestic (in Taiwan) technique of saving the file in PDF format and then printing, necessary to install Acrobat Reader in the clients'computers.

B. color (performed on MS Internet Explorer):

Since IE shows colors using a RGB table whereas the actual printing shows colors using a CMYK table, there may be a color difference between the two, given that the range of the RGB colors is larger than that of the CMYK colors. Therefore, there is a RGB to CMYK conversion table and a RGB manu with a shrunk color range for choosing colors, so as to avoid the problem of color difference.

When a client uploads the RGB colors and an image with a resolution less than 300 dpi, a warning message will be sent to the client asking the client to confirm the upload.

The offline proof making and reading is suitable for the cases requiring a color difference less than 10% and of large printing quantity. The conventional proof making means are digital making, traditional making and machine making, in which digital making is widely used if the quantity is small; for example using HP5000 ink jet printing, Xerox or Cannon carbon printing and Indigo ink printing.

1. offline content:

The electronic file for printing can be saved in a format acceptable to a printing plant.

2. offline color:

If a client has a strick requirement for the colors in the printed work, he or she has to upload image files or printing template in the CMYK format, whereby the color difference occurring in the transformation from RGB to CMYK will be avoided.

The above online automatic pricing mechanism combines the data of embedded in a web printing template with the conventional work sheet, transaction record, CRM, . . . etc. for a printing facility. The associated databanks can exchange data on the Internet, for the purpose of e-commerce.

The above preferred embodiments of the present invention show a breakthrough in the E2C business of printing that achieves a convenient, inexpensive and quick internet transaction mechanism, simplying the communications between the clients and the service provider. Also, the quality of conventional printing is maintained.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An online printing service system on Internet, comprising:
at least one client computer;
a web server;
a website for providing editing and other publication services;
a database management system for storing data produced by said editing and other publication services and for retrieving said data stored therein by selected websites and users;
a web interface through a web browser for providing a user with an interface for interactions with said website; and
an online or offline editor for providing a user with carrying out editing operations in a way selected from online fashion and offline fashion;
whereby a user will use said system to accomplish editing, typesetting and publication online via Internet; and
wherein said editing and other publication services further including the services of: making standard electronic files for printing web available; said electronic files are classified and ready for search; editing one of said electronic files; a user being not necessary to install a special editor and character fonts of various languages; online selecting paper type and quantity to print and online evaluating a price, whereby a purchase order will be accomplished online; text data, such as name, job title, e-mail address, extension phone number, in one of said electronic file being capable of being replaced by another set of text data; an edited file being capable of being shared with other authorized users, whereby a beginning user will be familiar with said system quickly; and online inquiring status of said purchase.

2. The online printing service system on the Internet of claim 1 wherein said editing and other publication services further including the serice of: (1) online selecting templates; (2) online editing; (3) online display and valuating price; and (4) inline ordering and purchasing; whereby a whole transaction for printing will be accomplished on the Internet.

3. A method for online editing, typesetting and publication, comprising the steps of:
(1) transforming online characters to vector graphics;
(2) compressing said vector graphics representing said online characters;
(3) compressing online bitmap images;
(4) online editing through VML; and
(5) online RGB/CMYK color conversion;
whereby content to print will be obtained in vector graphics and with quality of bitmap images.

4. The method of claim 3 wherein said step of transforming online characters to vector graphics utilizes ActiveX kernel components written in Visual C++ and ATL for being called by an ASP or VB NET program; retrieving vector data of a character (in TrueType) counter through a GDI+ API application function, thereby making a BIG5 or UNICODE character into a vector graphic; said vector graphic being saved in EMF(Enhanced-Format Metafile) format for replacing online characters by images.

5. The editor of claim 3 wherein said step of compressing online bitmap images utilizes a C++ compression program to compress WMF and EMF files into Compressed Windows Metafiles, in either WMZ or EMZ, compatible with the windows operational system; said compression being taken from a ZLIB standard algorithm library, capable of compressing Windows Enhanced-Format Metafile into EMZ (Compressed Windows Enhanced-Format Metafile) files for facilitating web transmission.

6. The editor of claim 3 wherein said step of compressing online bitmap images utilizes GDI+ and HalfTone to produces small-size files selected from BMP (bitmap), JPEG and PNG formats; small images for online preview being resized by an application program developed in GDI+API and HalfTone technique, whereby deleted pixels in resizing said original image will be compensated by a smooth algorithm to attain small images of better quality.

7. The editor of claim 3 wherein said step of VML online editing utilizes a web application developed by a language selected from DHTM, Java, JavaScript and Remote Script and saved in VML format, whereby a user at a client end will interact with said web application through the JavaScript language; a web browser for said web application being MS Internet Explorer with DHTML specification published by W3C organization; said system providing a user with JavaScript functions of editing a VML document, such as “open new”, deletion, moving, Zoom In/Out and aligning VML Shape objects; further, said system allowing a user to command a Remote Script written in the Java language published by SUN Corporation capable of transforming a document being converted into EMZ compressed vector graphics at said server end and, at same time, to deliver said EMZ document back to said client end for further editing.

8. The editor of claim 3 wherein said step of online RGB/CMYK color conversion provides a user with a RGB color table restricted to CMYK color range, whereby all the colors contained in said VML file will be correctly converted into effective CMYK values and said printed work after said online editing will have correct colors.
